(19) United States
(12) Patent Application Publication
(10) Pub. No.: US 2024/0134395 A1
(43) Pub. Date: Apr. 25, 2024

(54) MANAGEMENT SYSTEM OF WORK SITE AND MANAGEMENT METHOD OF WORK SITE

(71) Applicant: Komatsu Ltd., Tokyo (JP)

(72) Inventors: Misato Maeda, Tokyo (JP); Takashi Hiranaka, Tokyo (JP); Kenta Osagawa, Tokyo (JP)

(73) Assignee: Komatsu Ltd., Tokyo (JP)

(21) Appl. No.: 18/278,653

(22) PCT Filed: Jan. 20, 2022
(86) PCT No.: PCT/JP2022/002044

§ 371 Date: Aug. 23, 2023

(30) Foreign Application Priority Data
Mar. 29, 2021 (JP) 2021-058213

(51) Int. Cl. G05D 1/648

(52) U.S. Cl. CPC G05D 1/6484; G05D 2107/90

(57) ABSTRACT

A management system of a work site includes: a workplace data acquisition unit that acquires workplace data set in a workplace where an unmanned haul vehicle travels; and a sprinkling area setting unit that sets, on the basis of the workplace data, a sprinkling area on which the unmanned sprinkler vehicle sprinkles water in the workplace.

### FIELD

The present disclosure relates to a management system of a work site, and a management method of a work site.

### BACKGROUND

As disclosed in Patent Literature 1, sprinkling may be performed by a sprinkler truck at a work site.

### CITATION LIST

### Patent Literature

Patent Literature 1: US 2015/0233245 A

### SUMMARY

### Technical Problem

Diffusion of dust or sand dust at a work site is controlled by sprinkling. In a case of sprinkling water on a work site, there is a demand for a technique capable of efficiently sprinkling water on an area where dust or sand dust is likely to diffuse.

An object of the present disclosure is to efficiently sprinkling water to an area where dust or sand dust is likely to diffuse at a work site.

### Solution to Problem

According to an aspect of the present invention, a management system of a work site, the system comprises: a workplace data acquisition unit that acquires workplace data set in a workplace where an unmanned haul vehicle travels; and a sprinkling area setting unit that sets, on a basis of the workplace data, a sprinkling area on which an unmanned sprinkler vehicle sprinkles water in the workplace.

### Advantageous Effects of Invention

According to the present disclosure, it is possible to efficiently sprinkle water on an area where dust or sand dust is likely to diffuse at a work site.

### BRIEF DESCRIPTION OF DRAWINGS

FIG. 1 is a schematic diagram illustrating a management system of a work site according to an embodiment.

FIG. 2 is a perspective view illustrating an unmanned haul vehicle according to the embodiment.

FIG. 3 is a perspective view illustrating the unmanned sprinkler vehicle according to the embodiment.

FIG. 4 is a schematic diagram illustrating a work site according to the embodiment.

FIG. 5 is a functional block diagram illustrating the management system of the work site according to the embodiment.

FIG. 6 is a view for describing haul traveling data of the unmanned haul vehicle according to the embodiment.

FIG. 7 is a view for describing sprinkling traveling data of the unmanned sprinkler vehicle according to the embodiment.

FIG. 8 is a view for describing an example of a traveling area and a sprinkling area in a loading place according to the embodiment.

FIG. 9 is a view for describing an example of a traveling area and a sprinkling area in the loading place according to the embodiment.

FIG. 10 is a view for describing an example of a traveling area and a sprinkling area in a dirt dumping place according to the embodiment.

FIG. 11 is a view for describing an example of a traveling area and a sprinkling area in the dirt dumping place according to the embodiment.

FIG. 12 is a flowchart illustrating a management method of the loading place according to the embodiment.

FIG. 13 is a flowchart illustrating the management method of the dirt dumping place according to the embodiment.

### DESCRIPTION OF EMBODIMENTS

In the following, an embodiment according to the present disclosure will be described with reference to the drawings. However, the present disclosure is not limited to the embodiment. Components of the embodiment described in the following can be arbitrarily combined. In addition, there is a case where a part of the components is not used.

[Outline of a Management System]

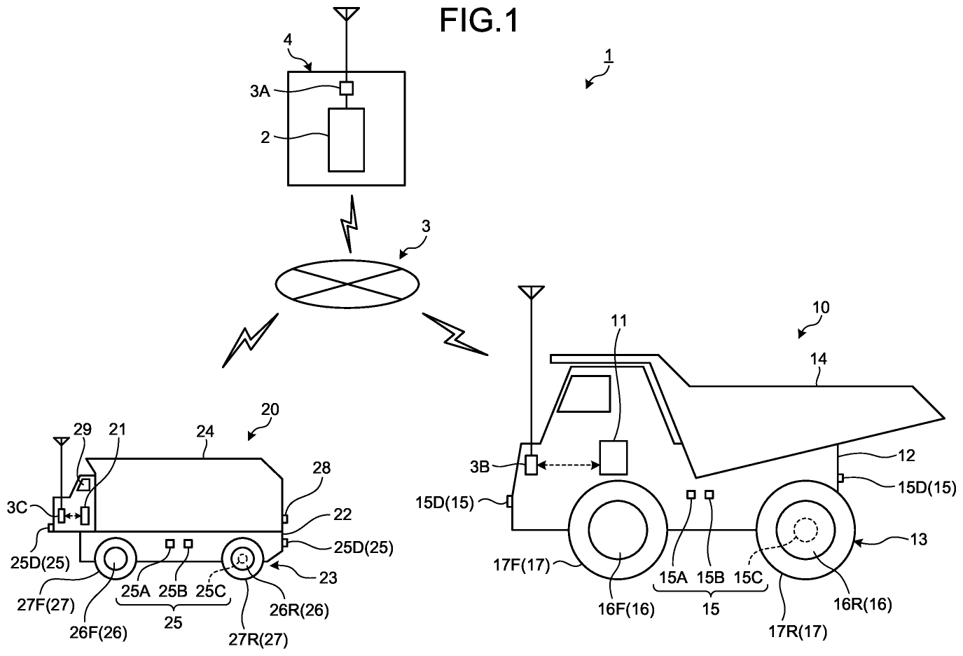

FIG. 1 is a schematic diagram illustrating a management system 1 of a work site according to an embodiment. The management system 1 manages an unmanned vehicle operating at a work site. The unmanned vehicle is a work vehicle that operates in an unmanned manner without depending on driving operation by a driver. In the embodiment, the unmanned vehicle operating at the work site includes an unmanned haul vehicle 10 and an unmanned sprinkler vehicle 20.

The unmanned haul vehicle 10 travels and hauls a load in an unmanned manner at the work site. Examples of the unmanned haul vehicle 10 include an unmanned dump truck. Examples of a load hauled by the unmanned haul vehicle 10 include an excavated object excavated at the work site.

The unmanned sprinkler vehicle 20 travels and sprinkles water in an unmanned manner in the work site. Examples of the unmanned sprinkler vehicle 20 include an unmanned sprinkler truck. The unmanned sprinkler vehicle sprinkles water to control diffusion of dust or sand dust at the work site.

The management system 1 includes a management device 2 and a communication system 3. The management device 2 is installed in a control facility 4 at the work site. The control facility 4 has an administrator.

The unmanned haul vehicle 10 includes a control device 11. The unmanned sprinkler vehicle 20 includes a control device 21. The management device 2, the control device 11, and the control device 21 wirelessly communicate with each other via the communication system 3. Wireless communication equipment 3A is connected to the management device 2. Wireless communication equipment 3B is connected to the control device 11. Wireless communication equipment 3C is connected to the control device 21. The communication system 3 includes the wireless communication equipment 3A, the wireless communication equipment 3B, and the wireless communication equipment 3C.

[Unmanned Haul Vehicle]

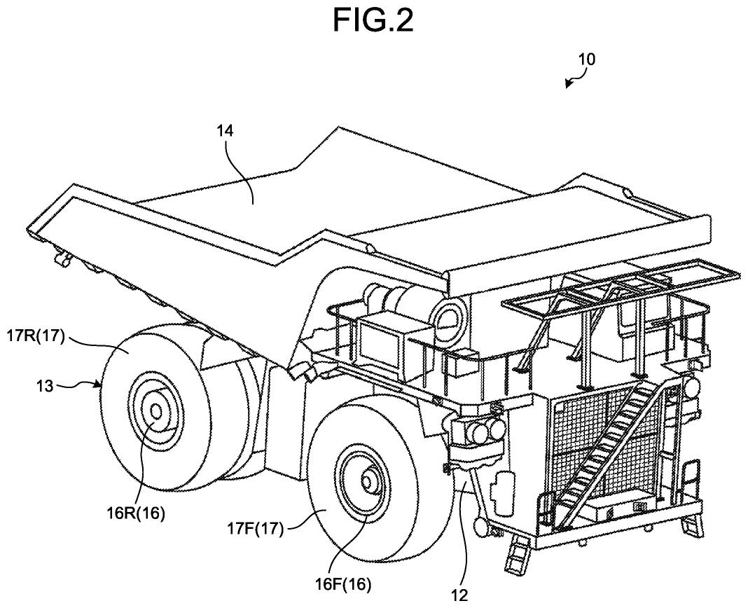

FIG. 2 is a perspective view illustrating the unmanned haul vehicle 10 according to the embodiment. As illustrated in FIG. 1 and FIG. 2, the unmanned haul vehicle includes the wireless communication equipment 3B, the control device 11, a vehicle body 12, a traveling device 13, a dump body 14, and a sensor system 15.

The vehicle body 12 includes a vehicle body frame. The vehicle body 12 is supported by the traveling device 13. The vehicle body 12 supports the dump body 14.

The traveling device 13 generates driving force for causing the unmanned haul vehicle 10 to travel. The traveling device 13 generates braking force for decelerating or stopping the unmanned haul vehicle 10. The traveling device 13 generates steering force for causing the unmanned haul vehicle 10 to turn. The traveling device 13 causes the unmanned haul vehicle 10 to move forward or backward. The traveling device 13 includes wheels 16. Tires 17 are mounted on the wheels 16. The wheels 16 include front wheels 16F and rear wheels 16R. The tires 17 include front tires 17F mounted on the front wheels 16F, and rear tires 17R mounted on the rear wheels 16R. When the wheels 16 rotate in a state in which the tires 17 are in contact with a road surface of the work site, the unmanned haul vehicle 10 travels on the work site.

The dump body 14 is a member on which a load is loaded. At least a part of the dump body 14 is arranged above the vehicle body 12.

The sensor system 15 includes a position sensor 15A, an azimuth sensor 15B, a speed sensor 15C, and an obstacle sensor 15D. The position sensor 15A detects a position of the unmanned haul vehicle 10. The position of the unmanned haul vehicle 10 is detected by utilization of a global navigation satellite system (GNSS). The position sensor 15A includes a GNSS receiver and detects the position of the unmanned haul vehicle 10 in a global coordinate system. The azimuth sensor 15B detects an azimuth of the unmanned haul vehicle 10. Examples of the azimuth sensor 15B include a gyroscope sensor. The speed sensor 15C detects a traveling speed of the unmanned haul vehicle 10. Examples of the speed sensor 15C include a pulse sensor that detects rotation of the wheels 16. The obstacle sensor 15D detects an obstacle around the unmanned haul vehicle 10. The obstacle sensor 15D detects the obstacle in a non-contact manner. Examples of the obstacle sensor 15D include a laser sensor (light detection and ranging (LIDAR)) or a radar sensor (radio detection and ranging (RADAR)).

[Unmanned Sprinkler Vehicle]

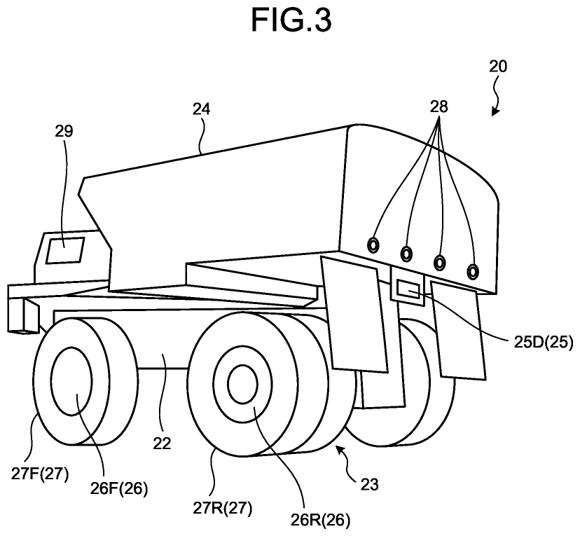

FIG. 3 is a perspective view illustrating the unmanned sprinkler vehicle 20 according to the embodiment. As illustrated in FIG. 1 and FIG. 3, the unmanned sprinkler vehicle 20 includes the wireless communication equipment 3C, the control device 21, a vehicle body 22, a traveling device 23, a tank 24, a sensor system 25, and a sprinkling spray 28.

The vehicle body 22 includes a vehicle body frame. The vehicle body 22 is supported by the traveling device 23. The vehicle body 22 supports the tank 24.

In the embodiment, a cab 29 is provided in the vehicle body 22. The cab 29 is provided in a front part of the vehicle body 22. The driver can get on the cab 29 and perform driving operation of the unmanned sprinkler vehicle 20. For example, when performing maintenance or inspection of the unmanned sprinkler vehicle 20, the driver performs the driving operation of the unmanned sprinkler vehicle 20.

In the embodiment, the unmanned sprinkler vehicle 20 operates in an unmanned manner at least when sprinkling water at the work site. Note that the cab 29 may not be provided in the unmanned sprinkler vehicle 20.

The traveling device 23 generates driving force for causing the unmanned sprinkler vehicle 20 to travel. The traveling device 23 generates braking force for decelerating or stopping the unmanned sprinkler vehicle 20. The traveling device 23 generates steering force for causing the unmanned sprinkler vehicle 20 to turn. The traveling device 23 causes the unmanned sprinkler vehicle to move forward or backward. The traveling device 23 includes wheels 26. Tires 27 are mounted on the wheels 26. The wheels 26 include front wheels 26F and rear wheels 26R. The front wheels 26F are steering wheels, and the rear wheels 26R are driving wheels. Note that both the front wheels 26F and the rear wheels 26R may be steering wheels. Both the front wheels 26F and the rear wheels 26R may be driving wheels. The front wheels 26F may be driving wheels, and the rear wheels 26R may be steering wheels. The tires 27 include front tires 27F mounted on the front wheels 26F and rear tires 27R mounted on the rear wheels 26R. When the wheels 26 rotate in a state in which the tires 27 are in contact with the road surface of the work site, the unmanned sprinkler vehicle 20 travels on the work site.

The tank 24 is a member that stores water for sprinkling. At least a part of the tank 24 is arranged above the vehicle body 22.

The sensor system 25 includes a position sensor 25A, an azimuth sensor 25B, a speed sensor 25C, and an obstacle sensor 25D. The position sensor 25A detects a position of the unmanned sprinkler vehicle 20. The position of the unmanned sprinkler vehicle 20 is detected by utilization of the global navigation satellite system (GNSS). The position sensor 25A includes a GNSS receiver and detects a position of the unmanned sprinkler vehicle 20 in the global coordinate system. The azimuth sensor 25B detects an azimuth of the unmanned sprinkler vehicle 20. Examples of the azimuth sensor 25B include a gyroscope sensor. The speed sensor 25C detects a traveling speed of the unmanned sprinkler vehicle 20. Examples of the speed sensor 25C include a pulse sensor that detects rotation of the wheels 26. The obstacle sensor 25D detects an obstacle around the unmanned sprinkler vehicle 20. The obstacle sensor 25D detects the obstacle in a non-contact manner. Examples of the obstacle sensor 25D include a laser sensor (light detection and ranging (LIDAR)) or a radar sensor (radio detection and ranging (RADAR)).

The sprinkling spray 28 sprays water in the tank 24. The sprinkling spray 28 is arranged in a rear part of the tank 24. The sprinkling spray 28 sprinkles water on a rear side of the unmanned sprinkler vehicle 20. In the embodiment, a plurality of the sprinkling sprays 28 is provided. The plurality of sprinkling sprays 28 is arranged at intervals in a vehicle width direction of the unmanned sprinkler vehicle 20 in the rear part of the tank 24. The vehicle width direction is a direction parallel to a rotation axis of the wheels 26 when the unmanned sprinkler vehicle 20 is in a straight traveling state.

[Work Site]

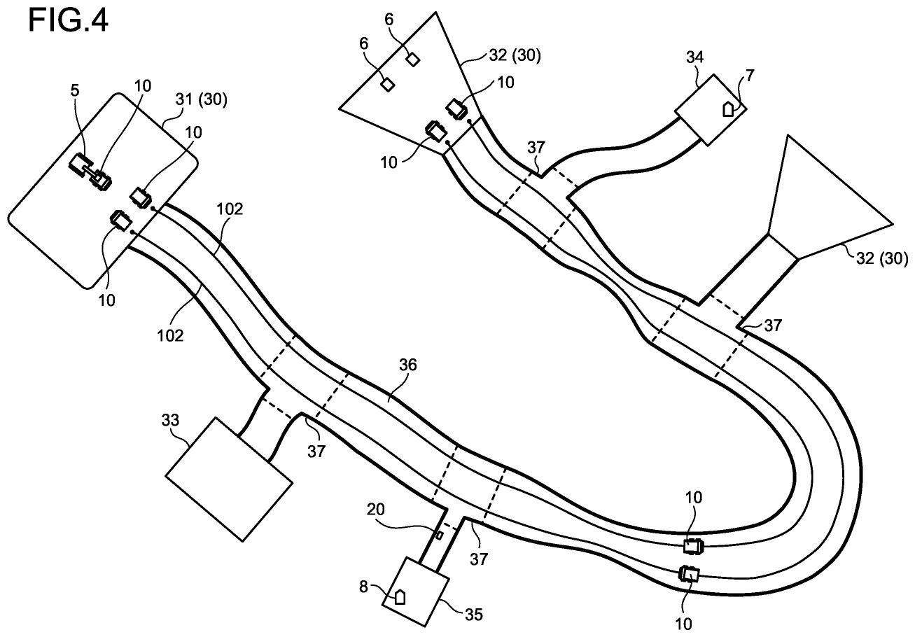

FIG. 4 is a schematic diagram illustrating the work site according to the embodiment. Examples of the work site include a mine or a quarry. The mine is a place or a plant where a mineral is mined. The quarry is a place or a plant where a stone is mined. At the work site, each of the unmanned haul vehicle 10 and the unmanned sprinkler vehicle 20 operates.

In the present embodiment, the work site is a mine. Examples of the mine include a metal mine in which metal is mined, a non-metal mine in which limestone is mined, or a coal mine in which coal is mined.

A workplace 30, a hardstand 33, a gas filling station 34, a water supply station 35, a traveling path 36, and an intersection 37 are provided in the work site. The workplace 30 include at least one of a loading place 31 and a dirt dumping place 32.

The loading place 31 is an area in which loading work in which a loader 5 loads a load onto the unmanned haul vehicle 10 is performed. The loader 5 operates in the loading place 31. Examples of the loader 5 include an excavator.

The dirt dumping place 32 is an area where dirt dumping work in which the unmanned haul vehicle 10 dumps the load is performed. A crusher 6 is provided in the dirt dumping place 32.

The hardstand 33 is an area where at least one of the unmanned haul vehicle 10 or the unmanned sprinkler vehicle 20 is parked.

The gas filling station 34 is an area where at least one of the unmanned haul vehicle 10 or the unmanned sprinkler vehicle 20 is supplied with gas. A gas pump 7 that supplies fuel is provided in the gas filling station 34.

The water supply station 35 is an area where the unmanned sprinkler vehicle 20 is supplied with water. In the water supply station 35, water for sprinkling is supplied to the tank 24. Water supply equipment 8 that supplies water to the tank 24 is provided in the water supply station 35.

The traveling path 36 is an area where the unmanned vehicle travels toward at least one of the workplace 30, the hardstand 33, the gas filling station 34, or the water supply station 35. The traveling path 36 is provided in such a manner as to connect at least the loading place 31 and the dirt dumping place 32. In the embodiment, the traveling path 36 is connected to each of the loading place 31, the dirt dumping place 32, the hardstand 33, the gas filling station 34, and the water supply station 35.

The intersection 37 is an area where a plurality of the traveling paths 36 intersects or an area where one traveling path 36 branches into a plurality of traveling paths 36.

[Management System]

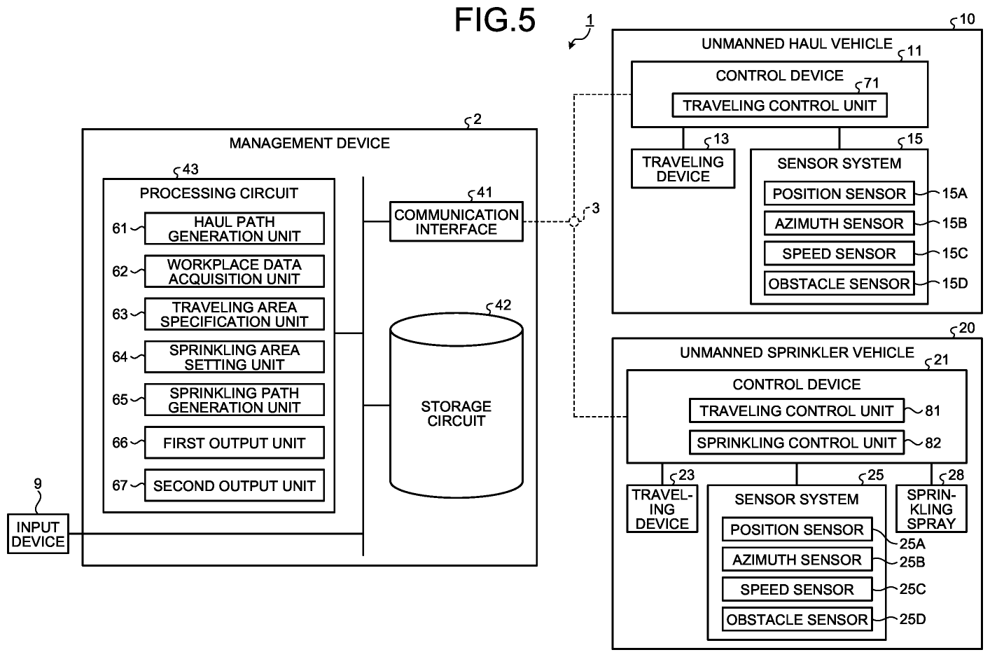

FIG. 5 is a functional block diagram illustrating the management system 1 of the work site according to the embodiment. The management system 1 includes the management device 2, the communication system 3, the control device 11, and the control device 21.

The management device 2 includes a computer system. The management device 2 is connected to the input device 9. The management device 2 includes a communication interface 41, a storage circuit 42, and a processing circuit 43.

The input device 9 is connected to the processing circuit 43. The input device 9 is operated by the administrator in the control facility 4. The input device 9 generates input data on the basis of operation by the administrator. The input data generated by the input device 9 is output to the processing circuit 43. Examples of the input device 9 include a touch panel, a computer keyboard, a mouse, or an operation button. Note that the input device 9 may be a non-contact-type input device including an optical sensor, or may be a voice input device.

The communication interface 41 is connected to the processing circuit 43. The communication interface 41 controls communication between the management device 2 and at least one of the control device 11 or the control device 21. The communication interface 41 communicates with at least one of the control device 11 or the control device 21 via the communication system 3.

The storage circuit 42 is connected to the processing circuit 43. The storage circuit 42 stores data. Examples of the storage circuit 42 include a nonvolatile memory or a volatile memory. Examples of the nonvolatile memory include a read only memory (ROM) or a storage. Examples of the storage include a hard disk drive (HDD) or a solid state drive (SSD). Examples of the volatile memory include a random access memory (RAM).

The processing circuit 43 performs arithmetic processing and control command output processing. Examples of the processing circuit 43 include a processor. Examples of the processor include a central processing unit (CPU) or a micro processing unit (MPU). A computer program is stored in the storage circuit 42. The processing circuit 43 exerts a predetermined function by acquiring and executing a computer program from the storage circuit 42.

The processing circuit 43 includes a haul path generation unit 61, a workplace data acquisition unit 62, a traveling area specification unit 63, a sprinkling area setting unit 64, a sprinkling path generation unit 65, a first output unit 66, and a second output unit 67.

The haul path generation unit 61 generates haul traveling data indicating a traveling condition of the unmanned haul vehicle 10 which condition is set at the work site. The traveling condition of the unmanned haul vehicle includes a haul path 102 indicating a target traveling route of the unmanned haul vehicle 10. The haul path generation unit 61 may generate the haul traveling data on the basis of the input data from the input device 9.

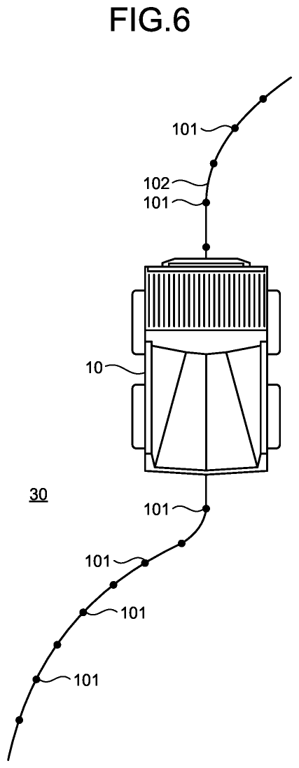

FIG. 6 is a view for describing the haul traveling data of the unmanned haul vehicle 10 according to the embodiment. The haul traveling data defines the traveling condition of the unmanned haul vehicle 10. The haul traveling data includes a course point 101, a haul path 102, a target position of the unmanned haul vehicle 10, a target azimuth of the unmanned haul vehicle 10, and a target traveling speed of the unmanned haul vehicle 10.

A plurality of the course points 101 is set at least in the workplace 30. In addition, the plurality of course points 101 is set on the traveling path 36. Each of the course points 101 defines a target position of the unmanned haul vehicle 10. A target azimuth and a target traveling speed of the unmanned haul vehicle 10 are set for each of the plurality of course points 101. The plurality of course points 101 is set at intervals. The intervals between the course points 101 are set to, for example, 1 [m] or more and 5 [m] or less. The intervals between the course points 101 may be uniform or non-uniform.

The haul path 102 is a virtual line indicating the target traveling route of the unmanned haul vehicle 10. The haul path 102 is defined by a track passing through the plurality of course points 101. The unmanned haul vehicle travels on the work site according to the haul path 102.

The target position of the unmanned haul vehicle is a target position of the unmanned haul vehicle 10 of when passing through the course point 101. The target position of the unmanned haul vehicle 10 may be defined in a local coordinate system of the unmanned haul vehicle 10 or may be defined in the global coordinate system.

The target azimuth of the unmanned haul vehicle is a target azimuth of the unmanned haul vehicle 10 of when passing through the course point 101.

The target traveling speed of the unmanned haul vehicle 10 is a target traveling speed of the unmanned haul vehicle 10 of when passing through the course point 101.

The workplace data acquisition unit 62 acquires workplace data set in the workplace 30 on which the unmanned haul vehicle 10 travels. The workplace data includes at least one of a position where the unmanned haul vehicle 10 travels and a position where the unmanned haul vehicle 10 stops in the workplace 30. The workplace data may be a factor that determines a traveling track of the unmanned haul vehicle 10 in the workplace 30, or may be the haul path 102 set in the workplace 30 or a traveling area 300 set in the workplace 30.

The workplace data includes a target point indicating a position to which the unmanned haul vehicle 10 is directed in the workplace 30. The target point is set in the workplace 30. The target point includes a work point indicating a position where work related to the unmanned haul vehicle 10 is performed.

A plurality of the work points is set in the workplace 30. Note that the number of work points set in the workplace 30 may be one. The work point is a position where work related to the unmanned haul vehicle 10 is performed. At the work point, the work related to the unmanned haul vehicle 10 is performed. The work related to the unmanned haul vehicle 10 includes loading work in which the loader 5 loads a load onto the unmanned haul vehicle 10. The work related to the unmanned haul vehicle 10 includes dirt dumping work in which the unmanned haul vehicle 10 dumps the load.

The work point includes at least one of a loading point LP indicating a position of the unmanned haul vehicle 10 in the loading work or a loader point LMP indicating a position of the loader 5 in the loading work. The loading point LP and the loader point LMP are set in the loading place 31. Only one loading point LP may be set in the loading place 31, or a plurality of loading points LP may be set therein. The unmanned haul vehicle 10 may stop at the loading point LP or may not stop at the loading point LP.

In addition, the work point includes a dirt dumping point DP indicating a position of the unmanned haul vehicle 10 in the dirt dumping work. The dirt dumping point DP is set in the dirt dumping place 32. Only one dirt dumping point DP may be set in the dirt dumping place 32, or a plurality of the dirt dumping points DP may be set therein. The unmanned haul vehicle 10 may stop at the dirt dumping point DP or may not stop at the dirt dumping point DP.

In addition, the workplace data includes a dirt dumping area DPA where the unmanned haul vehicle 10 can dump the load. The dirt dumping area DPA is set in the dirt dumping place 32. The dirt dumping point DP is set inside the dirt dumping area DPA.

In addition, the workplace data includes at least one of an entrance point EP indicating a position where the unmanned haul vehicle 10 enters the workplace 30 or an exit point MP indicating a position where the unmanned haul vehicle 10 leaves the workplace 30. Each of the entrance point EP and the exit point MP is set in the workplace 30. In a case of entering the workplace 30 from the traveling path 36, the unmanned haul vehicle 10 passes through the entrance point EP set in the workplace 30. The unmanned haul vehicle 10 that passes through the entrance point EP travels toward the work point set in the workplace 30. In a case of leaving the workplace 30, the unmanned haul vehicle 10 passes through the exit point MP set in the workplace 30. The unmanned haul vehicle 10 that passes through the exit point MP travels along the traveling path 36.

In addition, the workplace data includes the haul path 102 in the workplace 30 which path is generated by the haul path generation unit 61.

The traveling area specification unit 63 specifies the traveling area 300 of the unmanned haul vehicle 10 in the workplace 30 on the basis of the workplace data. The traveling area 300 is an area where the unmanned haul vehicle 10 travels in the workplace 30. The traveling area 300 includes at least one of an area where the unmanned haul vehicle 10 is scheduled to travel, an area where the unmanned haul vehicle 10 is likely to travel, and an area where the unmanned haul vehicle 10 has already traveled.

The traveling area specification unit 63 can specify the traveling area 300 of the unmanned haul vehicle on the basis of, for example, the target point of the workplace 30. That is, the traveling area specification unit 63 can specify the traveling area 300 of the unmanned haul vehicle 10 that travels toward the target point in the workplace 30.

The traveling area specification unit 63 can specify the traveling area 300 of the unmanned haul vehicle on the basis of, for example, at least one of the entrance point EP or the exit point MP of the workplace 30. That is, the traveling area specification unit 63 can specify the traveling area 300 of the unmanned haul vehicle that passes through at least one of the entrance point EP or the exit point MP of the workplace 30.

The traveling area specification unit 63 can specify the traveling area 300 of the unmanned haul vehicle on the basis of, for example, a position of the dirt dumping area DPA. That is, the traveling area specification unit 63 can specify the traveling area 300 of the unmanned haul vehicle 10 that travels toward the dirt dumping area DPA in the workplace 30.

The traveling area specification unit 63 can specify the traveling area 300 of the unmanned haul vehicle on the basis of, for example, a position of the haul path 102. That is, the traveling area specification unit 63 can specify the traveling area 300 of the unmanned haul vehicle 10 that travels along the haul path 102 set in the workplace 30.

In a case where the traveling area of the unmanned haul vehicle 10 is acquired as the workplace data by the workplace data acquisition unit 62 from the input device 9 or the like, the traveling area specification unit 63 can specify, as the traveling area 300, the traveling area acquired by the workplace data acquisition unit 62.

The sprinkling area setting unit 64 sets sprinkling data for controlling the sprinkling spray 28. The sprinkling data set by the sprinkling area setting unit 64 includes execution and a stop of sprinkling from the sprinkling spray 28. The sprinkling data set by the sprinkling area setting unit 64 includes a sprinkling amount from the sprinkling spray 28. In a case where a plurality of the sprinkling sprays 28 is provided in the unmanned sprinkler vehicle 20, the sprinkling data set by the sprinkling area setting unit 64 includes the number of sprinkling sprays 28 that execute sprinkling. In a case where the plurality of sprinkling sprays 28 is respectively installed in a plurality of positions of the unmanned sprinkler vehicle 20, the sprinkling data set by the sprinkling area setting unit 64 includes installation positions of the sprinkling sprays 28 that execute sprinkling.

In addition, the sprinkling data set by the sprinkling area setting unit 64 includes a sprinkling area 400 on which the unmanned sprinkler vehicle 20 sprinkles water in the workplace 30. The sprinkling area 400 is an area sprinkled from the sprinkling spray 28 of the unmanned sprinkler vehicle 20 in the workplace 30. The sprinkling area setting unit 64 sets the sprinkling area 400, on which the unmanned sprinkler vehicle 20 sprinkles water in the workplace 30, on the basis of the workplace data acquired by the workplace data acquisition unit 62.

In the embodiment, the sprinkling area setting unit 64 sets the sprinkling area 400, on which the unmanned sprinkler vehicle 20 sprinkles water in the workplace 30, on the basis of the traveling area 300 specified by the traveling area specification unit 63. The sprinkling area setting unit 64 sets the sprinkling area 400 in such a manner that at least a part of the traveling area 300 specified by the traveling area specification unit 63 is included in the sprinkling area 400. That is, the sprinkling area setting unit 64 sets the sprinkling area 400 in such a manner that at least a part of the traveling area 300 specified by the traveling area specification unit 63 is sprinkled.

In the embodiment, the sprinkling area setting unit 64 sets the sprinkling area 400 in such a manner that the entire traveling area 300 specified by traveling area specification unit 63 is included in the sprinkling area 400. That is, the sprinkling area setting unit 64 sets the sprinkling area 400 in such a manner that the entire traveling area 300 specified by the traveling area specification unit 63 is sprinkled.

Note that the sprinkling area setting unit 64 may set the sprinkling area 400 in such a manner that a part of the traveling area 300 specified by the traveling area specification unit 63 is included in the sprinkling area 400.

The sprinkling path generation unit 65 generates the sprinkling traveling data indicating the traveling condition of the unmanned sprinkler vehicle 20 which condition is set at the work site. The traveling condition of the unmanned sprinkler vehicle 20 includes a sprinkling path 202 indicating a target traveling route of the unmanned sprinkler vehicle 20. The sprinkling path generation unit 65 generates the sprinkling path 202 on the basis of the workplace data acquired by the workplace data acquisition unit 62. The sprinkling path generation unit 65 generates the sprinkling path 202 of the unmanned sprinkler vehicle 20 in such a manner that sprinkling is performed in the sprinkling area 400 set by the sprinkling area setting unit 64. The sprinkling path generation unit 65 may generate the sprinkling path 202 on the basis of the traveling area 300 of the unmanned haul vehicle 10 which area is specified by the traveling area specification unit 63.

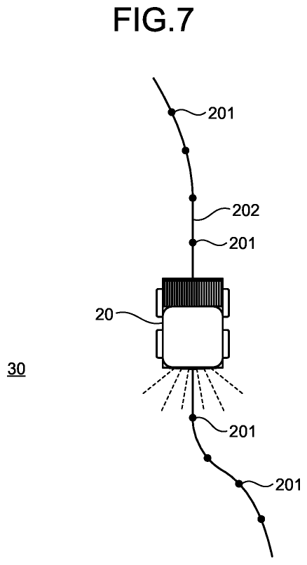

FIG. 7 is a view for describing the sprinkling traveling data of the unmanned sprinkler vehicle 20 according to the embodiment. The sprinkling traveling data defines the traveling condition of the unmanned sprinkler vehicle 20. The sprinkling traveling data includes a course point 201, a sprinkling path 202, a target position of the unmanned sprinkler vehicle 20, a target azimuth of the unmanned sprinkler vehicle 20, and a target traveling speed of the unmanned sprinkler vehicle 20. A plurality of the course points 201 is set at least in the workplace 30. In addition, the plurality of course points 201 is set on the traveling path 36. The sprinkling path 202 includes a virtual line indicating the target traveling route of the unmanned sprinkler vehicle 20. A function of the haul traveling data and a function of the sprinkling traveling data are similar. Description of the sprinkling traveling data is omitted.

The first output unit 66 (haul traveling data output unit) transmits the haul traveling data generated by the haul path generation unit 61 to the unmanned haul vehicle 10. The first output unit 66 transmits the haul traveling data from the communication interface 41 to the control device 11 of the unmanned haul vehicle 10.

The second output unit 67 (sprinkling traveling data output unit) transmits the sprinkling traveling data generated by the sprinkling path generation unit 65 to the unmanned sprinkler vehicle 20. The second output unit 67 transmits the sprinkling traveling data from the communication interface 41 to the control device 21 of the unmanned sprinkler vehicle 20.

The second output unit 67 transmits the sprinkling data including the sprinkling area 400 set by the sprinkling area setting unit 64 to the unmanned sprinkler vehicle 20. The second output unit 67 transmits the sprinkling data including the sprinkling area 400 from the communication interface 41 to the control device 21 of the unmanned sprinkler vehicle 20.

The control device 11 includes a computer system. Similarly to the management device 2, the control device 11 includes a communication interface, a storage circuit, and a processing circuit. The control device 11 includes a traveling control unit 71 that controls the traveling device 13. The traveling control unit 71 controls the traveling device 13 on the basis of the haul traveling data transmitted from the management device 2.

The control device 21 includes a computer system. Similarly to the management device 2, the control device 21 includes a communication interface, a storage circuit, and a processing circuit. The control device 21 includes a traveling control unit 81 that controls the traveling device 23, and a sprinkling control unit 82 that controls the sprinkling spray 28. The traveling control unit 81 controls the traveling device 23 on the basis of the sprinkling traveling data transmitted from the management device 2. The sprinkling control unit 82 controls the sprinkling spray 28 on the basis of the sprinkling data transmitted from the management device 2.

The traveling control unit 71 controls the traveling device 13 on the basis of the haul traveling data and detection data of the sensor system 15. On the basis of detection data of the position sensor 15A and detection data of the azimuth sensor 15B, the traveling control unit 71 controls the traveling device 13 in such a manner that the unmanned haul vehicle 10 travels on the basis of the haul path 102. That is, the traveling control unit 71 controls the traveling device 13 in such a manner that a deviation between a detection position of the unmanned haul vehicle 10, which position is detected by the position sensor 15A at the time of passing through the course point 101, and the target position of the unmanned haul vehicle which target position is set at the course point 101 becomes small. Furthermore, the traveling control unit 71 controls the traveling device 13 in such a manner that a deviation between a detection azimuth of the unmanned haul vehicle 10, which azimuth is detected by the azimuth sensor 15B at the time of passing through the course point 101, and the target azimuth of the unmanned haul vehicle 10 which target azimuth is set at the course point 101 becomes small. In addition, on the basis of detection data of the speed sensor 15C, the traveling control unit 71 controls the traveling device 13 in such a manner that the unmanned haul vehicle 10 travels at the target traveling speed. That is, the traveling control unit 71 controls the traveling device 13 in such a manner that a deviation between a detected traveling speed of the unmanned haul vehicle 10, which speed is detected by the speed sensor 15C at the time of passing through the course point 101, and the target traveling speed of the unmanned haul vehicle 10 which target traveling speed is set at the course point 101 becomes small.

The traveling control unit 81 controls the traveling device 23 on the basis of the sprinkling traveling data and detection data of the sensor system 25. On the basis of detection data of the position sensor 25A and detection data of the azimuth sensor 25B, the traveling control unit 81 controls the traveling device 23 in such a manner that the unmanned sprinkler vehicle 20 travels on the basis of the sprinkling path 202. In addition, on the basis of detection data of the speed sensor 25C, the traveling control unit 81 controls the traveling device 23 in such a manner that the unmanned sprinkler vehicle 20 travels at the target traveling speed.

[Sprinkling Control in a Loading Place]

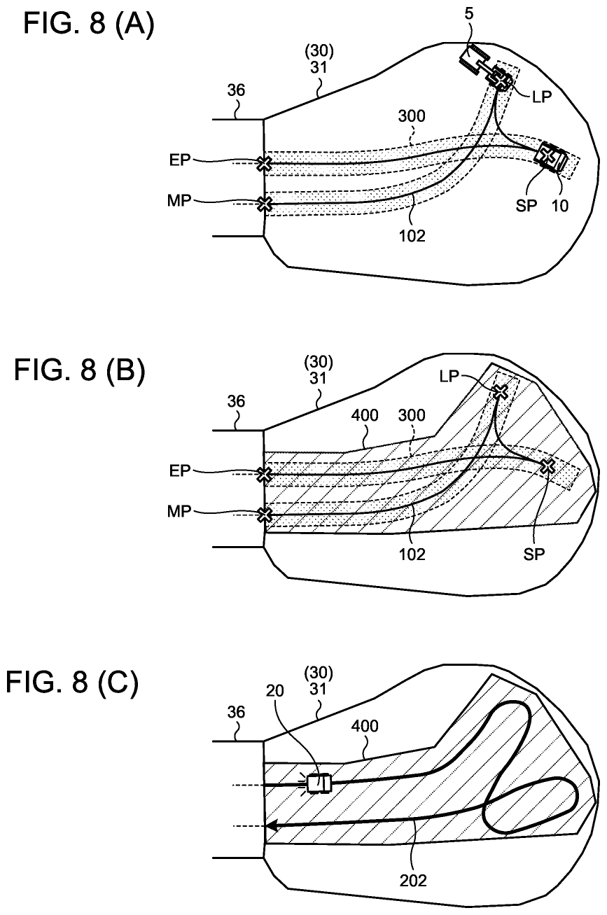

FIG. 8 is a view for describing an example of the traveling area 300 and the sprinkling area 400 in the loading place 31 according to the embodiment.

As illustrated in FIG. 8(A), the haul path generation unit 61 generates the haul traveling data in such a manner that the unmanned haul vehicle 10 travels toward a loading point LP. The unmanned haul vehicle 10 travels in accordance with the haul traveling data in the loading place 31. An entrance point EP, a switchback point SP, a loading point LP, and an exit point MP are set in the loading place 31. Each of the entrance point EP, the switchback point SP, the loading point LP, and the exit point MP may be set by the administrator. The administrator can set each of the entrance point EP, the switchback point SP, the loading point LP, and the exit point MP by operating the input device 9.

The unmanned haul vehicle 10 that travels along the traveling path 36 and passes through the entrance point EP enters the loading place 31 while moving forward. The unmanned haul vehicle 10 that enters the loading place 31 switches back at the switchback point SP and then enters the loading point LP while moving backward. The switchback is operation in which the unmanned haul vehicle 10 moving forward changes a traveling direction and travels in a target direction while moving backward. The switchback is performed on the basis of the haul traveling data.

After the unmanned haul vehicle 10 enters the loading point LP while moving backward and stops at the loading point LP, the loading work is performed. The loader 5 loads a load onto the dump body 14 of the unmanned haul vehicle 10.

The unmanned haul vehicle 10 that ends the loading work moves forward to the exit point MP. The unmanned haul vehicle 10 leaves the loading place 31 after passing through the exit point MP while moving forward.

As illustrated in FIG. 8(A), the traveling area specification unit 63 specifies the traveling area 300 on the basis of the haul path 102. The traveling area specification unit 63 specifies the traveling area 300 on the basis of, for example, the haul path 102 and a vehicle width of the unmanned haul vehicle 10. The traveling area 300 specifies the traveling area 300 in such a manner that the entire haul path 102 is included in the traveling area 300.

Note that a plurality of the switchback points SP may be set in the loading place 31, and a plurality of the haul paths 102 may be set in the loading place 31. In this case, the plurality of haul paths 102 is set in the loading place 31 in such a manner as to respectively have different target traveling routes. Note that the switchback point SP may not be set in the loading place 31. In this case, the haul path 102 is set in the loading place 31 in such a manner as to be a target traveling route on which the unmanned haul vehicle 10 does not switch back.

After the traveling area 300 is specified, as illustrated in FIG. 8(B), the sprinkling area setting unit 64 sets the sprinkling area 400 in such a manner that the entire traveling area 300 is included in the sprinkling area 400. The sprinkling area setting unit 64 sets the sprinkling area 400 in such a manner that an edge of the sprinkling area 400 surrounds the traveling area 300. In the example illustrated in FIG. 8, the sprinkling area setting unit 64 sets the sprinkling area 400 in such a manner that the entire edge of the sprinkling area 400 is arranged outside an edge of the traveling area 300. The sprinkling area 400 is smaller than the loading place 31.

As illustrated in FIG. 8(C), the sprinkling path generation unit 65 generates the sprinkling path 202 in such a manner that the unmanned sprinkler vehicle 20 sprinkles water on the sprinkling area 400. The second output unit 67 transmits the sprinkling traveling data generated by the sprinkling path generation unit 65 to the unmanned sprinkler vehicle 20. As illustrated in FIG. 8(C), the unmanned sprinkler vehicle 20 travels in the loading place 31 on the basis of the sprinkling path 202 while sprinkling water from the sprinkling spray 28 in such a manner that water is sprinkled on at least a part of the sprinkling area 400.

In the embodiment, the sprinkling path generation unit 65 generates the sprinkling path 202 in such a manner that the unmanned sprinkler vehicle 20 sprinkles water on the sprinkling area 400 while moving forward without moving backward. In a case where the sprinkling spray 28 is provided in a rear part of the unmanned sprinkler vehicle 20, the unmanned sprinkler vehicle 20 preferably sprinkles water from the sprinkling spray 28 while moving forward without moving backward. Note that the sprinkling path generation unit 65 may generate the sprinkling path 202 in such a manner that the unmanned sprinkler vehicle 20 sprinkles water on the sprinkling area 400 while moving backward. The sprinkling path generation unit 65 may generate the sprinkling path 202 in such a manner that the unmanned sprinkler vehicle 20 sprinkles water on the sprinkling area 400 while moving forward and moving backward.

Note that the sprinkling area setting unit 64 may set the sprinkling area 400 in such a manner that a part of the traveling area 300 is included in the sprinkling area 400. The sprinkling area setting unit 64 may set the sprinkling area 400 in such a manner that the edge of the traveling area 300 is arranged inside the edge of the sprinkling area 400.

Note that the haul path generation unit 61 may generate the haul path 102 on the basis of the loading point LP indicating the position of the unmanned haul vehicle 10 in the loading work, or may generate the haul path 102 on the basis of the loader point LMP indicating the position of the loader 5 in the loading work. For example, the haul path generation unit 61 may predict the loading point LP from the loader point LMP and generate the haul path 102 on the basis of the predicted loading point LP.

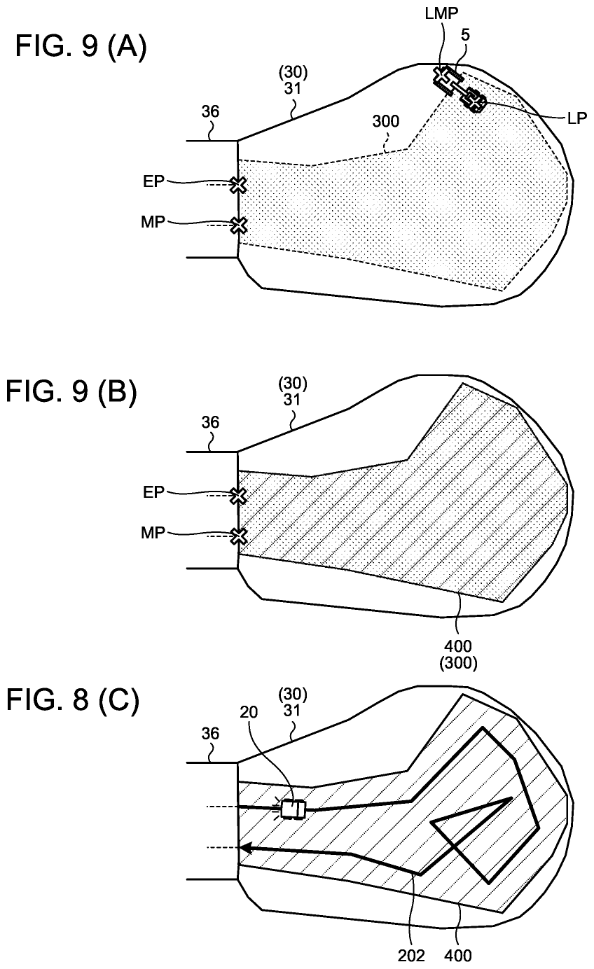

FIG. 9 is a view for describing an example of the traveling area 300 and the sprinkling area 400 in the loading place 31 according to the embodiment.

As illustrated in FIG. 9(A), there is a case where the haul path 102 is not set in the loading place 31 and the loading point LP, the entrance point EP, and the exit point MP are set. Even when the haul path 102 is not set, the traveling area specification unit 63 can specify the traveling area 300 of the unmanned haul vehicle 10 on the basis of the loading point LP, the entrance point EP, and the exit point MP. In the embodiment, the traveling area specification unit 63 estimates a plurality of traveling tracks, on which the unmanned haul vehicle 10 is likely to travel, on the basis of relative positions of the loading point LP, the entrance point EP, and the exit point MP. The traveling area specification unit 63 can set the traveling area 300 in such a manner that the plurality of estimated traveling tracks is included. Note that when a distance between the switchback point SP and the loading point LP is too long, work efficiency of the loading work is decreased. The traveling area specification unit 63 sets the switchback point SP on the basis of the loading point LP in such a manner that the decrease in the work efficiency of the loading work is controlled, and estimates a plurality of traveling tracks on the basis of the set switchback point SP.

Note that the traveling area specification unit 63 may specify the traveling area 300 of the unmanned haul vehicle 10 on the basis of the loading point LP without using the entrance point EP and the exit point MP.

After the traveling area 300 is specified, as illustrated in FIG. 9(B), the sprinkling area setting unit 64 sets the sprinkling area 400 in such a manner that the entire traveling area 300 is included in the sprinkling area 400. The sprinkling area setting unit 64 sets the sprinkling area 400 in such a manner that the edge of the sprinkling area 400 surrounds the traveling area 300. In the example illustrated in FIG. 9, the sprinkling area setting unit 64 sets the sprinkling area 400 in such a manner that the edge of the sprinkling area 400 coincides with the edge of the traveling area 300. The sprinkling area 400 is smaller than the loading place 31.

Note that the sprinkling area setting unit 64 may set the sprinkling area 400 in such a manner that a part of the traveling area 300 is included in the sprinkling area 400. The sprinkling area setting unit 64 may set the sprinkling area 400 in such a manner that the edge of the traveling area 300 is arranged inside the edge of the sprinkling area 400.

As illustrated in FIG. 9(C), the sprinkling path generation unit 65 generates the sprinkling path 202 in such a manner that the unmanned sprinkler vehicle 20 sprinkles water on the sprinkling area 400. The second output unit 67 transmits the sprinkling traveling data generated by the sprinkling path generation unit 65 to the unmanned sprinkler vehicle 20. As illustrated in FIG. 9(C), the unmanned sprinkler vehicle 20 travels on the loading place 31 on the basis of the sprinkling path 202 while sprinkling water from the sprinkling spray 28 in such a manner that water is sprinkled on the entire sprinkling area 400.

Note that the traveling area specification unit 63 may specify the traveling area 300 on the basis of the loading point LP indicating the position of the unmanned haul vehicle 10 in the loading work, or may specify the traveling area 300 on the basis of the loader point LMP indicating the position of the loader 5 in the loading work.

[Sprinkling Control in a Dirt Dumping Place]

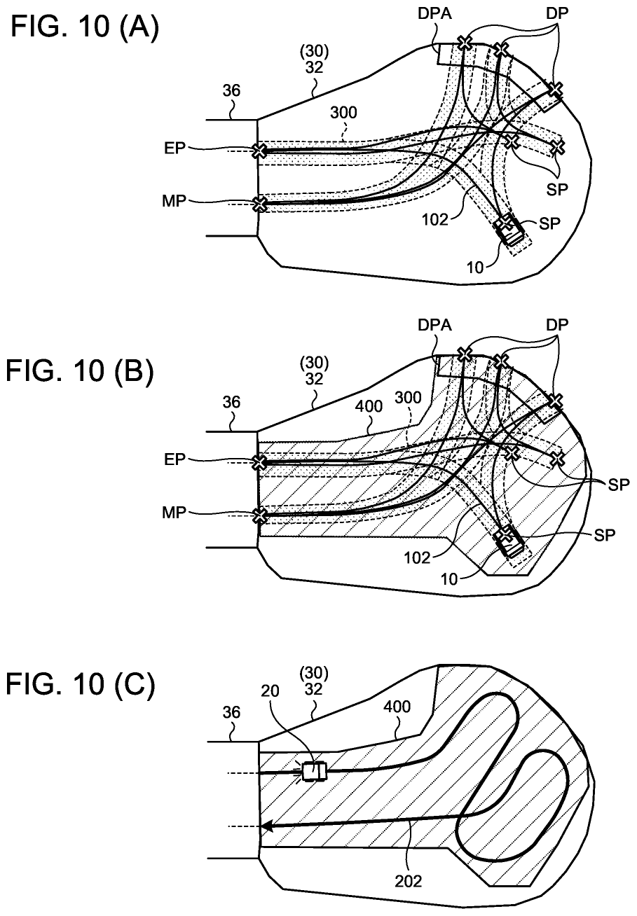

FIG. 10 is a view for describing an example of the traveling area 300 and the sprinkling area 400 in the dirt dumping place 32 according to the embodiment.

As illustrated in FIG. 10(A), the haul path generation unit 61 generates the haul traveling data in such a manner that the unmanned haul vehicle 10 travels toward the dirt dumping point DP. The unmanned haul vehicle 10 travels in accordance with the haul traveling data in the dirt dumping place 32. The entrance point EP, the switchback point SP, the dirt dumping point DP, and the exit point MP are set in the dirt dumping place 32. In the embodiment, a plurality of the dirt dumping points DP is set. The dirt dumping points DP are set inside the dirt dumping area DPA. Each of the entrance point EP, the switchback point SP, the dirt dumping points DP, the exit point MP, and the dirt dumping area DPA may be set by the administrator. The administrator can operate the input device 9 and set each of the entrance point EP, the switchback point SP, the dirt dumping points DP, the exit point MP, and the dirt dumping area DPA.

The unmanned haul vehicle 10 that travels along the traveling path 36 and passes through the entrance point EP enters the dirt dumping place 32 while moving forward. The unmanned haul vehicle 10 that enters the dirt dumping place 32 switches back at the switchback point SP and then enters one of the dirt dumping points DP while moving backward. The switchback is performed on the basis of the haul traveling data.

After the unmanned haul vehicle 10 enters the dirt dumping point DP while moving backward and stops at the dirt dumping point DP, the dirt dumping work is performed. The unmanned haul vehicle 10 causes the dump body 14 to perform dump operation, and dumps the load from the dump body 14.

The unmanned haul vehicle 10 that ends the dirt dumping work moves forward to the exit point MP. The unmanned haul vehicle 10 leaves the dirt dumping place 32 after passing through the exit point MP while moving forward.

As illustrated in FIG. 10(A), a plurality of the switchback points SP is set in the dirt dumping place 32. A plurality of the haul paths 102 is set in the dirt dumping place 32. The plurality of haul paths 102 is set in the dirt dumping place 32 in such a manner as to respectively have different target traveling routes.

As illustrated in FIG. 10(A), the traveling area specification unit 63 specifies the traveling area 300 on the basis of the plurality of haul paths 102. The traveling area specification unit 63 specifies the traveling area 300 on the basis of, for example, the haul paths 102 and the vehicle width of the unmanned haul vehicle 10. The traveling area 300 specifies the traveling area 300 in such a manner that all of the plurality of haul paths 102 is included in the traveling area 300.

After the traveling area 300 is specified, as illustrated in FIG. 10(B), the sprinkling area setting unit 64 sets the sprinkling area 400 in such a manner that the entire traveling area 300 is included in the sprinkling area 400. The sprinkling area setting unit 64 sets the sprinkling area 400 in such a manner that the edge of the sprinkling area 400 surrounds the traveling area 300. In the example illustrated in FIG. 10, the sprinkling area setting unit 64 sets the sprinkling area 400 in such a manner that the entire edge of the sprinkling area 400 is arranged outside the edge of the traveling area 300. The sprinkling area 400 is smaller than the dirt dumping place 32.

As illustrated in FIG. 10(C), the sprinkling path generation unit 65 generates the sprinkling path 202 in such a manner that the unmanned sprinkler vehicle 20 sprinkles water on the sprinkling area 400. The second output unit 67 transmits the sprinkling traveling data generated by the sprinkling path generation unit 65 to the unmanned sprinkler vehicle 20. As illustrated in FIG. 10(C), the unmanned sprinkler vehicle 20 travels on the dirt dumping place 32 on the basis of the sprinkling path 202 while sprinkling water from the sprinkling spray 28 in such a manner that water is sprinkled on at least a part of the sprinkling area 400.

In the embodiment, the sprinkling path generation unit 65 generates the sprinkling path 202 in such a manner that the unmanned sprinkler vehicle 20 sprinkles water on the sprinkling area 400 while moving forward without moving backward. In a case where the sprinkling spray 28 is provided in a rear part of the unmanned sprinkler vehicle 20, the unmanned sprinkler vehicle 20 preferably sprinkles water from the sprinkling spray 28 while moving forward without moving backward. Note that the sprinkling path generation unit 65 may generate the sprinkling path 202 in such a manner that the unmanned sprinkler vehicle 20 sprinkles water on the sprinkling area 400 while moving backward. The sprinkling path generation unit 65 may generate the sprinkling path 202 in such a manner that the unmanned sprinkler vehicle 20 sprinkles water on the sprinkling area 400 while moving forward and moving backward.

Note that the haul path generation unit 61 may generate the haul paths 102 on the basis of the dirt dumping points DP indicating the positions of the unmanned haul vehicle 10 in the dirt dumping work, or may generate the haul paths 102 on the basis of the position of the dirt dumping area DPA where the unmanned haul vehicle 10 can dump the load.

Note that the sprinkling area setting unit 64 may set the sprinkling area 400 in such a manner that a part of the traveling area 300 is included in the sprinkling area 400. The sprinkling area setting unit 64 may set the sprinkling area 400 in such a manner that the edge of the traveling area 300 is arranged inside the edge of the sprinkling area 400.

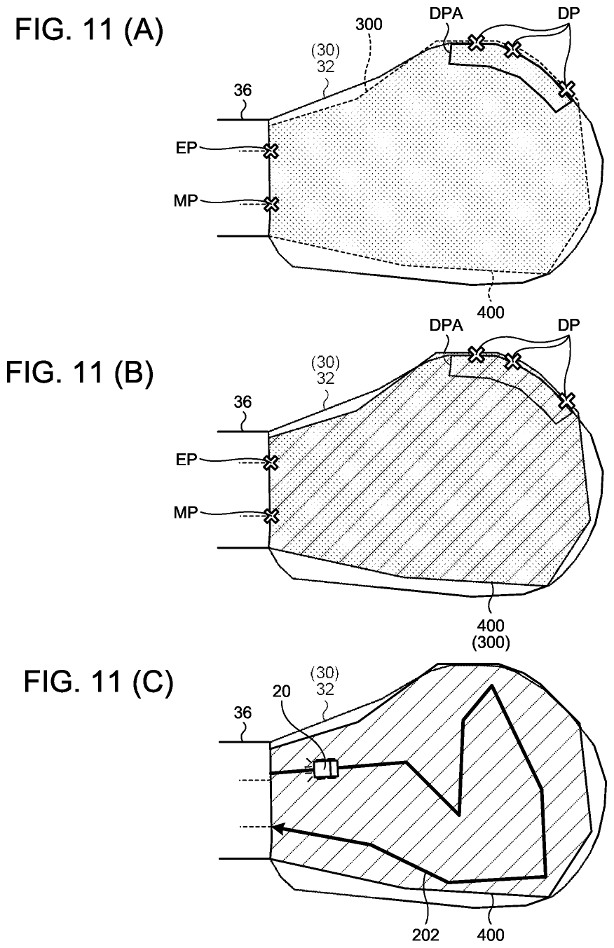

FIG. 11 is a view for describing an example of the traveling area 300 and the sprinkling area 400 in the dirt dumping place 32 according to the embodiment.

As illustrated in FIG. 11(A), there is a case where no haul path 102 is set in the dirt dumping place 32 and the dirt dumping point DP, the entrance point EP, and the exit point MP are set. Even when the haul path 102 is not set, the traveling area specification unit 63 can specify the traveling area 300 of the unmanned haul vehicle on the basis of the dirt dumping point DP, the entrance point EP, and the exit point MP. In the embodiment, the traveling area specification unit 63 estimates a plurality of traveling tracks, on which the unmanned haul vehicle 10 is likely to travel, on the basis of relative positions of the dirt dumping point DP, the entrance point EP, and the exit point MP. The traveling area specification unit 63 can set the traveling area 300 in such a manner that the plurality of estimated traveling tracks is included. Note that when a distance between the switchback point SP and the dirt dumping point DP is too long, work efficiency of the dirt dumping work is decreased. The traveling area specification unit 63 sets the switchback point SP on the basis of the dirt dumping point DP in such a manner that the decrease in the work efficiency of the dirt dumping work is controlled, and estimates a plurality of traveling tracks on the basis of the set switchback point SP.

Note that the traveling area specification unit 63 may specify the traveling area 300 of the unmanned haul vehicle 10 on the basis of the dirt dumping point DP without using the entrance point EP and the exit point MP.

After the traveling area 300 is specified, as illustrated in FIG. 11(B), the sprinkling area setting unit 64 sets the sprinkling area 400 in such a manner that the entire traveling area 300 is included in the sprinkling area 400. The sprinkling area setting unit 64 sets the sprinkling area 400 in such a manner that the edge of the sprinkling area 400 surrounds the traveling area 300. In the example illustrated in FIG. 11, the sprinkling area setting unit 64 sets the sprinkling area 400 in such a manner that the edge of the sprinkling area 400 coincides with the edge of the traveling area 300. The sprinkling area 400 is smaller than the dirt dumping place 32.

Note that the sprinkling area setting unit 64 may set the sprinkling area 400 in such a manner that a part of the traveling area 300 is included in the sprinkling area 400. The sprinkling area setting unit 64 may set the sprinkling area 400 in such a manner that the edge of the traveling area 300 is arranged inside the edge of the sprinkling area 400.

As illustrated in FIG. 11(C), the sprinkling path generation unit 65 generates the sprinkling path 202 in such a manner that the unmanned sprinkler vehicle 20 sprinkles water on the sprinkling area 400. The second output unit 67 transmits the sprinkling traveling data generated by the sprinkling path generation unit 65 to the unmanned sprinkler vehicle 20. As illustrated in FIG. 11(C), the unmanned sprinkler vehicle 20 travels on the dirt dumping place 32 on the basis of the sprinkling path 202 while sprinkling water from the sprinkling spray 28 in such a manner that water is sprinkled on the entire sprinkling area 400.

Note that the traveling area specification unit 63 may specify the traveling area 300 on the basis of the dirt dumping point DP indicating the position of the unmanned haul vehicle 10 in the dirt dumping work, or may specify the traveling area 300 on the basis of the position of the dirt dumping area DPA where the unmanned haul vehicle 10 can dump the load.

[Management Method of a Loading Place]

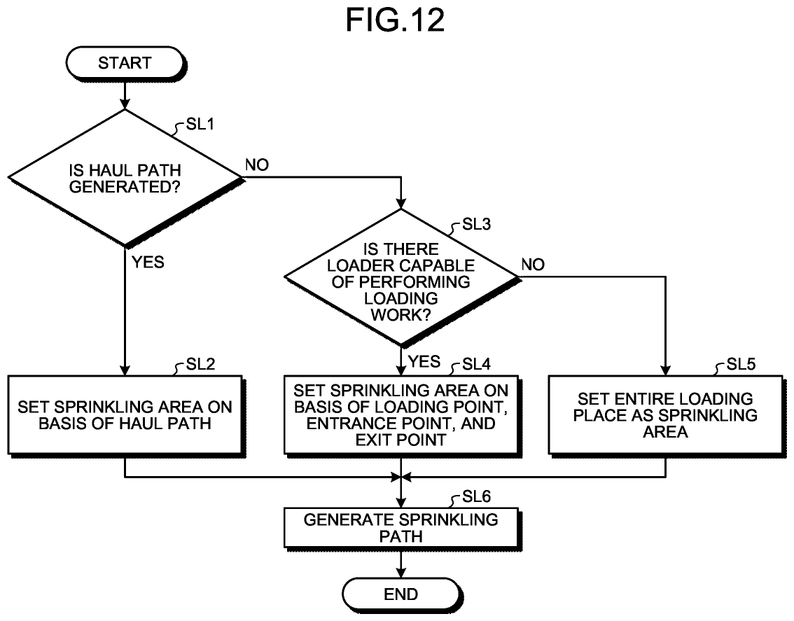

FIG. 12 is a flowchart illustrating a management method of the loading place 31 according to the embodiment.

The traveling area specification unit 63 determines whether the haul path 102 is generated (Step SL1).

In a case where it is determined in Step SL1 that the haul path 102 is generated (Step SL1: Yes), the traveling area specification unit 63 specifies the traveling area 300 on the basis of the haul path 102. The sprinkling area setting unit 64 sets the sprinkling area 400 on the basis of the traveling area 300. That is, the sprinkling area setting unit 64 sets the sprinkling area 400 on the basis of the haul path 102 (Step SL2).

In a case where it is determined in Step SL1 that the haul path 102 is not generated (Step SL1: No), the traveling area specification unit 63 determines whether there is the loader 5 capable of performing the loading work (Step SL3).

In Step SL3, in a case where it is determined that there is the loader 5 capable of performing the loading operation (Step SL3: Yes), the sprinkling area setting unit 64 sets the sprinkling area 400 on the basis of a position of the loader 5 capable of performing the loading work. The loading point LP is set in the vicinity of the position of the loader 5 capable of performing the loading work. The sprinkling area setting unit 64 sets the sprinkling area 400 on the basis of the loading point LP, the entrance point EP, and the exit point MP (Step SL4).

In a case where it is determined in Step SL3 that there is no loader 5 that can perform the loading work (Step SL3: No), the sprinkling area setting unit 64 sets the entire loading place 31 as the sprinkling area 400 (Step SL5).

The sprinkling path generation unit 65 generates the sprinkling path 202 on the basis of the sprinkling area 400 set on the basis of one piece of processing in Step SL2, Step SL4, and Step SL5 (Step SL6).

The sprinkling traveling data including the sprinkling path 202 generated by the sprinkling path generation unit 65 is transmitted to the control device 21 of the unmanned sprinkler vehicle 20 via the communication system 3. On the basis of the sprinkling path 202, the control device 21 controls the unmanned sprinkler vehicle in such a manner that water is sprinkled on the sprinkling area 400. The unmanned sprinkler vehicle 20 travels on the loading place 31 on the basis of the sprinkling path 202 while sprinkling water from the sprinkling spray 28.

[Management Method of a Dirt Dumping Place]

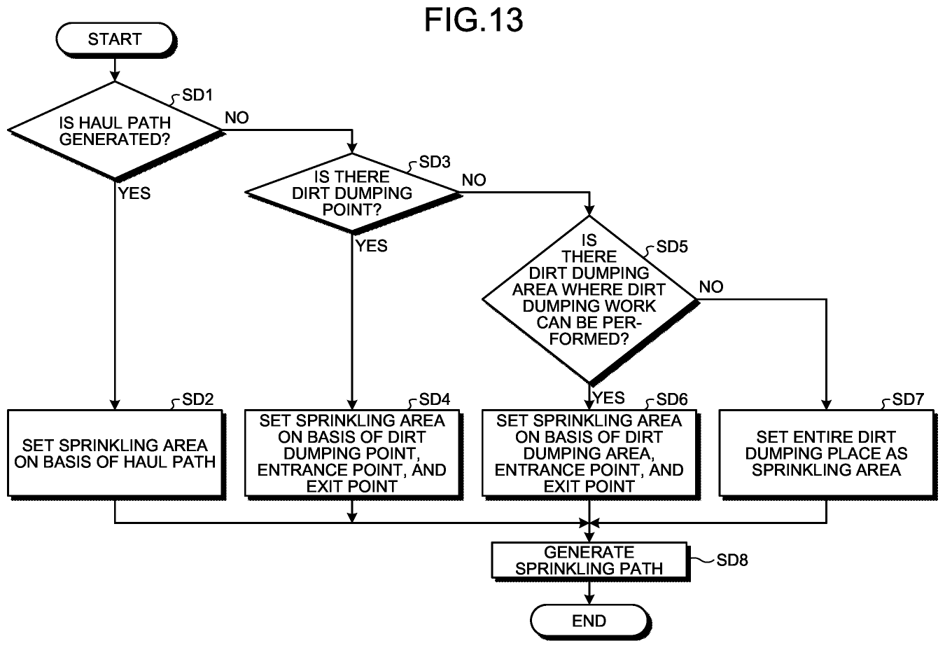

FIG. 13 is a flowchart illustrating a management method of the dirt dumping place 32 according to the embodiment.

The traveling area specification unit 63 determines whether the haul path 102 is generated (Step SD1).

In a case where it is determined in Step SD1 that the haul path 102 is generated (Step SD1: Yes), the traveling area specification unit 63 specifies the traveling area 300 on the basis of the haul path 102. The sprinkling area setting unit 64 sets the sprinkling area 400 on the basis of the traveling area 300. That is, the sprinkling area setting unit 64 sets the sprinkling area 400 on the basis of the haul path 102 (Step SD2).

In a case where it is determined in Step SD1 that the haul path 102 is not generated (Step SD1: No), the traveling area specification unit 63 determines whether there is the dirt dumping point DP (Step SD3).

In a case where it is determined in Step SD3 that the dirt dumping point DP is present (Step SD3: Yes), the sprinkling area setting unit 64 sets the sprinkling area 400 on the basis of the dirt dumping point DP, the entrance point EP, and the exit point MP (Step SD4).

In a case where it is determined in Step SD3 that there is no dirt dumping point DP (Step SD3: No), the traveling area specification unit 63 determines whether there is the dirt dumping area DPA where dirt dumping work can be performed (Step SD5).

In a case where it is determined in Step SD5 that there is the dirt dumping area DPA where the dirt dumping work can be performed (Step SD5: Yes), the sprinkling area setting unit 64 sets the sprinkling area 400 on the basis of the position of the dirt dumping area DPA, the entrance point EP, and the exit point MP (Step SD6).

In Step SD5, in a case where it is determined that there is no dirt dumping area DPA where the dirt dumping work can be performed (Step SD5: No), the sprinkling area setting unit 64 sets the entire dirt dumping place 32 as the sprinkling area 400 (Step SD7).

The sprinkling path generation unit 65 generates the sprinkling path 202 on the basis of the sprinkling area 400 set on the basis of one piece of processing in Step SD2, Step SD4, Step SD6, and Step SD7 (Step SD8).

The sprinkling traveling data including the sprinkling path 202 generated by the sprinkling path generation unit 65 is transmitted to the control device 21 of the unmanned sprinkler vehicle 20 via the communication system 3. On the basis of the sprinkling path 202, the control device 21 controls the unmanned sprinkler vehicle in such a manner that water is sprinkled on the sprinkling area 400. The unmanned sprinkler vehicle 20 travels on the dirt dumping place 32 on the basis of the sprinkling path 202 while sprinkling water from the sprinkling spray 28.

[Effect]

As described above, according to the embodiment, the sprinkling area 400 is set on the basis of the workplace data set in the workplace 30 where the unmanned haul vehicle 10 travels. Workplace data in the loading place 31 includes at least one of the loading point LP, the loader point LMP, the entrance point EP of the loading place 31, the exit point MP of the loading place 31, the haul path 102 set in the loading place 31, or the traveling area 300. Workplace data in the dirt dumping place 32 includes at least one of the dirt dumping point DP, the dirt dumping area DPA, the entrance point EP of the dirt dumping place 32, the exit point MP of the dirt dumping place 32, the haul path 102 set in the dirt dumping place 32, or the traveling area 300. The position where the unmanned haul vehicle 10 travels or stops is an area where dust or sand dust is likely to diffuse in the workplace 30. Since the sprinkling area 400 is set on the basis of the workplace data including the position where the unmanned haul vehicle travels or stops, the unmanned sprinkler vehicle 20 can efficiently sprinkle water on an area where dust or sand dust is likely to diffuse.

In the embodiment, the traveling area 300 of the unmanned haul vehicle 10 in the workplace 30 is specified on the basis of the workplace data for acquiring the workplace data set in the workplace 30 where the unmanned haul vehicle 10 travels. The sprinkling area 400 is set on the basis of the specified traveling area 300. The traveling area 300 of the unmanned haul vehicle 10 is an area where dust or sand dust is likely to diffuse in the workplace 30. Since the sprinkling area 400 is set on the basis of the traveling area 300, the unmanned sprinkler vehicle 20 can efficiently sprinkle water on the traveling area 300 where dust or sand dust is likely to diffuse.

In a case where the traveling area 300 is specified in the loading place 31, not only the loading point LP but also at least one of the entrance point EP or the exit point MP are used, whereby the traveling area 300 is specified with high accuracy. Similarly, in a case where the traveling area 300 is specified in the dirt dumping place 32, not only the dirt dumping point DP but also at least one of the entrance point EP or the exit point MP are used, whereby the traveling area 300 is specified with high accuracy.

In a case where the haul path 102 of the unmanned haul vehicle 10 is generated in the workplace 30, the traveling area 300 is specified on the basis of the haul path 102, whereby the traveling area 300 is specified with high accuracy.

The sprinkling path 202 of the unmanned sprinkler vehicle 20 is generated in such a manner that sprinkling is performed in the sprinkling area 400 set by the sprinkling area setting unit 64. The unmanned sprinkler vehicle 20 travels on the workplace 30 while sprinkling water on the basis of the sprinkling data including the sprinkling area 400 and the sprinkling path 202, whereby water can be uniformly sprinkled on the sprinkling area 400.

### Other Embodiments

In the above-described embodiment, workplace data may include a work plan of an unmanned haul vehicle 10 in a workplace 30. For example, with respect to a plurality of unmanned haul vehicles 10 and a plurality of workplaces 30 at a work site, it is determined as a work plan which of the plurality of unmanned haul vehicles 10 is caused to travel on a haul path 102 of which workplace 30. Then, a workplace data acquisition unit 62 may acquire the work plan of the unmanned haul vehicles 10 in the workplaces 30, and a sprinkling area setting unit 64 may set a sprinkling area 400 on the basis of the work plan of the unmanned haul vehicles 10 in the workplaces 30. Furthermore, workplace data may also include topography data of the workplaces 30. For example, the workplace data acquisition unit 62 may acquire topography data of the workplaces 30, and the sprinkling area setting unit 64 may set the sprinkling area 400 on the basis of the topography data of the workplaces when setting all the workplaces 30 as the sprinkling area 400.

In the above-described embodiment, at least a part of a function of a control device 11 and a function of a control device 21 may be provided in a management device 2, or at least a part of a function of the management device 2 may be provided in one or both of the control device 11 and the control device 21. For example, in the above-described embodiment, the control device 11 may have a function of a haul path generation unit 61, the function of the workplace data acquisition unit 62, and a function of a traveling area specification unit 63. The control device 21 may have the function of the sprinkling area setting unit 64 and a function of a sprinkling path generation unit 65.

In the above-described embodiment, the haul path generation unit 61, the workplace data acquisition unit 62, the traveling area specification unit 63, the sprinkling area setting unit 64, the sprinkling path generation unit 65, a first output unit 66, and a second output unit 67 may be respectively configured by different pieces of hardware.

### REFERENCE SIGNS LIST

1 MANAGEMENT SYSTEM
2 MANAGEMENT DEVICE
3 COMMUNICATION SYSTEM
3A WIRELESS COMMUNICATION EQUIPMENT
3B WIRELESS COMMUNICATION EQUIPMENT
3C WIRELESS COMMUNICATION EQUIPMENT
4 CONTROL FACILITY
5 LOADER
6 CRUSHER
7 GAS PUMP
8 WATER SUPPLY EQUIPMENT
9 INPUT DEVICE
10 UNMANNED HAUL VEHICLE
11 CONTROL DEVICE
12 VEHICLE BODY
13 TRAVELING DEVICE
14 DUMP BODY
15 SENSOR SYSTEM
15A POSITION SENSOR
15B AZIMUTH SENSOR
15C SPEED SENSOR
15D OBSTACLE SENSOR
16 WHEEL
16F FRONT WHEEL
16R REAR WHEEL
17 TIRE
17F FRONT TIRE
17R REAR TIRE
20 UNMANNED SPRINKLER VEHICLE
21 CONTROL DEVICE
22 VEHICLE BODY
23 TRAVELING DEVICE
24 TANK
25 SENSOR SYSTEM
25A POSITION SENSOR
25B AZIMUTH SENSOR
25C SPEED SENSOR
25D OBSTACLE SENSOR
26 WHEEL
26F FRONT WHEEL
26R REAR WHEEL
27 TIRE
27F FRONT TIRE
27R REAR TIRE
28 SPRINKLING SPRAY
29 CAB
30 WORKPLACE
31 LOADING PLACE
32 DIRT DUMPING PLACE
33 HARDSTAND
34 GAS FILLING STATION
35 WATER SUPPLY STATION
36 TRAVELING PATH
37 INTERSECTION
41 COMMUNICATION INTERFACE
42 STORAGE CIRCUIT
43 PROCESSING CIRCUIT
61 HAUL PATH GENERATION UNIT
62 WORKPLACE DATA ACQUISITION UNIT
63 TRAVELING AREA SPECIFICATION UNIT
64 SPRINKLING AREA SETTING UNIT
65 SPRINKLING PATH GENERATION UNIT
66 FIRST OUTPUT UNIT
67 SECOND OUTPUT UNIT
71 TRAVELING CONTROL UNIT
81 TRAVELING CONTROL UNIT
82 SPRINKLING CONTROL UNIT
101 COURSE POINT
102 HAUL PATH
201 COURSE POINT
202 SPRINKLING PATH
300 TRAVELING AREA
400 SPRINKLING AREA
DP DIRT DUMPING POINT
DPA DIRT DUMPING AREA
EP ENTRANCE POINT
LP LOADING POINT
LMP LOADER POINT
MP EXIT POINT
SP SWITCHBACK POINT

1. A management system of a work site, the system comprising:
a workplace data acquisition unit that acquires workplace data set in a workplace where an unmanned haul vehicle travels; and
a sprinkling area setting unit that sets, on a basis of the workplace data, a sprinkling area on which an unmanned sprinkler vehicle sprinkles water in the workplace.

2. The management system of a work site according to claim 1, further comprising
a haul path generation unit that generates a haul path indicating a target traveling route of the unmanned haul vehicle, wherein
the workplace data includes the haul path.

3. The management system of a work site according to claim 1, wherein
the workplace data includes a target point indicating a position to which the unmanned haul vehicle is directed.

4. The management system of a work site according to claim 3, wherein
the target point includes a work point indicating a position where work related to the unmanned haul vehicle is performed.

5. The management system of a work site according to claim 4, wherein
the work includes loading work in which a loader loads a load onto the unmanned haul vehicle, and
the work point includes at least one of a loading point indicating a position of the unmanned haul vehicle in the loading work or a loader point indicating a position of the loader in the loading work.

6. The management system of a work site according to claim 4, wherein
the work includes dirt dumping work in which the unmanned haul vehicle dumps a load, and
the work point includes a dirt dumping point indicating a position of the unmanned haul vehicle in the dirt dumping work.

7. The management system of a work site according to claim 4, wherein
a plurality of the work points is set in the workplace.

8. The management system of a work site according to claim 1, wherein
the workplace data includes at least one of an entrance point indicating a position where the unmanned haul vehicle enters the workplace or an exit point indicating a position where the unmanned haul vehicle leaves the workplace.

9. The management system of a work site according to claim 1, wherein
the workplace data includes a dirt dumping area where the unmanned haul vehicle can dump a load.

10. The management system of a work site according to claim 1, further comprising
a traveling area specification unit that specifies, on a basis of the workplace data, a traveling area of the unmanned haul vehicle in the workplace, wherein
the sprinkling area setting unit sets the sprinkling area on a basis of the traveling area.

11. The management system of a work site according to claim 10, wherein
the sprinkling area setting unit sets the sprinkling area in such a manner that at least a part of the traveling area is included in the sprinkling area.

12. The management system of a work site according to claim 1, further comprising
a sprinkling path generation unit that generates, on a basis of the workplace data, a sprinkling path indicating a target traveling route of the unmanned sprinkler vehicle.

13. The management system of a work site according to claim 12, wherein
the sprinkling path generation unit generates the sprinkling path in such a manner that water is sprinkled on the sprinkling area.

14. A management method of a work site, the method comprising:
setting, on a basis of workplace data set in a workplace where an unmanned haul vehicle travels, a sprinkling area in the workplace; and
controlling an unmanned sprinkler vehicle in such a manner that water is sprinkled on the sprinkling area.

15. The management method of a work site according to claim 14, wherein
the workplace data includes a target point indicating a position to which the unmanned haul vehicle is directed.

16. The management method of a work site according to claim 15, wherein
the target point includes a work point indicating a position where work related to the unmanned haul vehicle is performed.

17. The management method of a work site according to claim 14, wherein
the workplace data includes at least one of an entrance point indicating a position where the unmanned haul vehicle enters the workplace or an exit point indicating a position where the unmanned haul vehicle leaves the workplace.

18. The management method of a work site according to claim 14, wherein
the workplace data includes a dirt dumping area where the unmanned haul vehicle can dump a load.

19. The management method of a work site according to claim 14, wherein
the workplace data includes a haul path indicating a target traveling route of the unmanned haul vehicle.

20. The management method of a work site according to claim 14, further comprising:
generating, on a basis of the workplace data, a sprinkling path indicating a target traveling route of the unmanned sprinkler vehicle in such a manner that water is sprinkled on the sprinkling area; and
controlling the unmanned sprinkler vehicle to travel on a basis of the sprinkling path.
